(19) United States
(12) Patent Application Publication
(10) Pub. No.: US 2014/0160395 A1
(43) Pub. Date: Jun. 12, 2014

(54) LIQUID CRYSTAL DISPLAY

(71) Applicant: Samsung Display Co., Ltd., Yongin-city (KR)

(72) Inventors: Jae Hwa PARK, Gumi-si (KR); Je Hyeong PARK, Hwaseong-si (KR); Sang-Myoung LEE, Seoul (KR); Su Wan WOO, Osan-si (KR); Ki Pyo HONG, Suwon-si (KR); Sang Woo WHANGBO, Seoul (KR)

(73) Assignee: Samsung Display Co., Ltd., Yongin-city (KR)

(21) Appl. No.: 13/894,730

(22) Filed: May 15, 2013

(30) Foreign Application Priority Data
Dec. 11, 2012 (KR) 10-2012-0143866

(51) Int. Cl. G02F 1/1343

(52) U.S. Cl. CPC G02F 1/1343
USPC 349/61; 349/139

(57) ABSTRACT

A liquid crystal display includes an insulation substrate, a pixel electrode, a microcavity layer, a common electrode, and a layer. The pixel electrode is disposed on the substrate. The microcavity layer is disposed on the pixel electrode and includes a plurality of microcavities including liquid crystal molecules disposed therein. The common electrode is disposed on the microcavity layer. The layer is disposed on the common electrode and includes an organic material. The layer comprises a refractive index of more than 1.6 and less than 2.0.

### CROSS-REFERENCE TO RELATED APPLICATION

This application claims priority from and the benefit of Korean Patent Application No. 10-2012-0143866, filed on Dec. 11, 2012, which is incorporated by reference for all purposes as if set forth herein.

### BACKGROUND

1. Field

Exemplary embodiments relate to display technology, and more particularly, to a liquid crystal display including a liquid crystal layer formed in a microcavity and a manufacturing method thereof.

2. Discussion

Conventional liquid crystal displays typically include two display panels with is field generating electrodes, such as a pixel electrode and a common electrode formed thereon, and a liquid crystal layer disposed therebetween.

To facilitate the display of images, an electric field is typically imposed on the liquid crystal layer by applying voltages to the field generating electrodes. This orients liquid crystal molecules of the liquid crystal layer and controls polarization of incident light.

Liquid crystal displays including an embedded microcavity (EM) structure are devices in which a sacrificial layer, such as a photoresist layer, is formed, a supporting member is disposed thereon, the sacrificial layer is then removed by, for instance, an ashing process, and liquid crystal is disposed in a void (or empty space, cavity, etc.) formed as a result of the sacrificial layer being removed.

To support the void where the sacrificial layer is removed, a layer (e.g., a roof layer) including an organic material is formed. Instead of using the layer of organic material, some liquid crystal displays do not use an overlying insulation substrate made of, for instance, glass. However, when the layer of organic material is used, optical characteristics may be deteriorated. Therefore, there is a need for an approach that provides efficient, cost effective techniques to provide display devices including EM structures and such layers of organic materials without deterioration of the optical characteristics of the display devices.

The above information disclosed in this Background section is only for enhancement of understanding of the background of the invention, and therefore, it may contain information that does not form the prior art that is already known in this country to a person of ordinary skill in the art.

### SUMMARY

Exemplary embodiments provide a liquid crystal display including an organic material layer formed on a microcavity layer including liquid crystal without deterioration of the optical characteristics of the display device.

Additional aspects will be set forth in the detailed description which follows and, in part, will be apparent from the disclosure, or may be learned by practice of the invention.

According to exemplary embodiments, a liquid crystal display, includes: a substrate; a pixel electrode disposed on the substrate; a microcavity layer disposed on the pixel electrode, the microcavity layer including a plurality of microcavities including liquid crystal molecules disposed therein; a common electrode disposed on the microcavity layer; and a layer disposed on the common electrode, the layer including an organic material. The layer includes a refractive index of more than 1.6 and less than 2.0.

According to exemplary embodiments, a liquid crystal display, includes: a substrate; a pixel electrode disposed on the substrate; a microcavity layer disposed on the pixel electrode, the microcavity layer including a plurality of microcavities including liquid crystal molecules disposed therein; a common electrode disposed on the microcavity layer; and a layer disposed on the common electrode. The layer includes a convex pattern.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, is illustrate exemplary embodiments of the invention, and together with the description serve to explain the principles of the invention.

FIG. 1 is a plan view of a liquid crystal display, according to exemplary embodiments.

FIG. 2 is a cross-sectional view of the liquid crystal display of FIG. 1 taken along sectional line II-II, according to exemplary embodiments.

FIG. 3 is a schematic cross-sectional view of a liquid crystal display, according to exemplary embodiments.

FIG. 4 is a graph comparing normalized transmittance with refractive index, according to exemplary embodiments.

FIG. 5 illustrates a chemical formula of an organic layer additive, according to exemplary embodiments.

FIG. 6 is a cross-sectional view of a liquid crystal display, according to exemplary embodiments.

FIG. 7 is a cross-sectional view of a liquid crystal display, according to exemplary embodiments.

FIG. 8 illustrates various viewpoints of the liquid crystal display of FIG. 7, according to exemplary embodiments.

FIGS. 9 and 10 are cross-sectional views of a liquid crystal display, according to exemplary embodiments.

FIG. 11 is a circuit diagram of a liquid crystal display, according to exemplary embodiments.

FIG. 12 is a plan view of a liquid crystal display, according to exemplary is embodiments.

FIG. 13 is a circuit diagram of a liquid crystal display, according to exemplary embodiments.

FIG. 14 is a plan view of a liquid crystal display, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” and/or the like, may be used herein for descriptive purposes, and thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and as such, the spatially relative descriptors used herein interpreted accordingly.

The terminology used herein is for the purpose of describing particular embodiments and is not intended to be limiting. As used herein, the singular forms “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

While exemplary embodiments are described in association with liquid crystal display devices, it is contemplated that exemplary embodiments may be utilized in association with other or equivalent display devices, such as various self-emissive and/or non-self-emissive display technologies. For instance, self-emissive display devices may include organic light emitting displays (OLED), plasma display panels (PDP), etc., whereas non-self-emissive display devices may include electrophoretic displays (EPD), electrowetting displays (EWD), and/or the like.

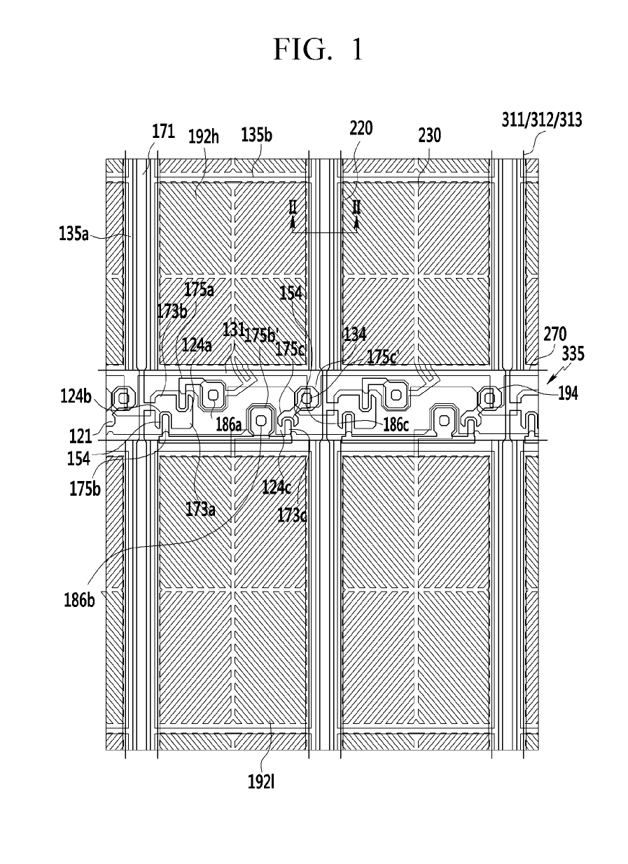

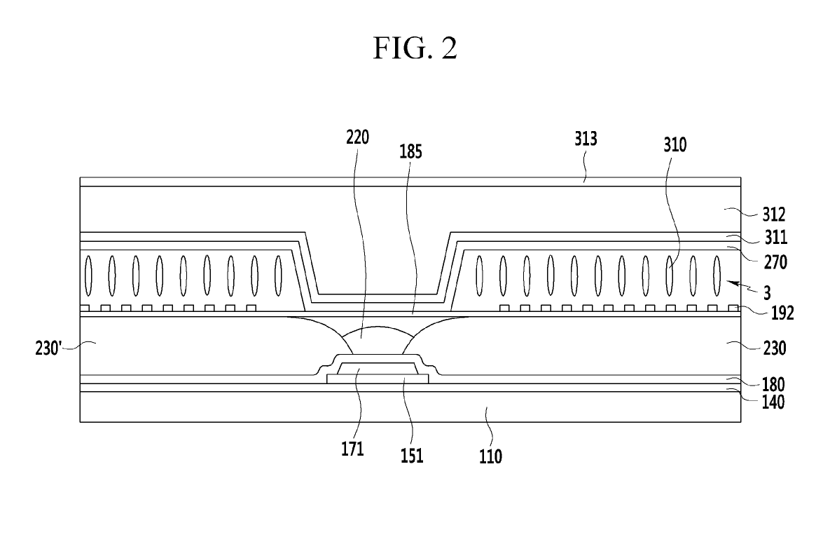

FIG. 1 is a plan view of a liquid crystal display, according to exemplary embodiments. FIG. 2 is a cross-sectional view of the liquid crystal display device of FIG. 1 taken along sectional line II-II.

According to exemplary embodiments, a gate line 121 and a storage voltage line 131 are formed on an insulation substrate 110 made of any suitable material, such as, for example, transparent glass, plastic, and/or the like. The gate line 121 includes a first gate electrode 124a, a second gate electrode 124b, and a third gate electrode 124c. The storage voltage line 131 includes storage electrodes 135a and 135b, and a protrusion 134 protruding in a direction of the gate line 121. The structure of the storage electrodes 135a and 135b surrounds a first subpixel electrode 192h and a second subpixel electrode 192l of an adjacent (or previous) pixel. A horizontal portion 135b of the storage electrode may be a wire connected to a horizontal portion 135b of an adjacent (or previous) pixel.

A gate insulating layer 140 is formed on the gate line 121 and the storage voltage line 131. A semiconductor 151 positioned below a data line 171, a semiconductor 155 positioned below source/drain electrodes 173a-c/175a-c, and a semiconductor 154 positioned at a channel portion of a thin film transistor are formed on the gate insulating layer 140.

A plurality of ohmic contacts (not shown) may be formed on each of the semiconductors 151, 154, and 155, as well as disposed between the data line 171 and the source/drain electrodes.

Data conductors 171, 173a, 173b, 173c, 175a, 175b, and 175c are formed on each of the semiconductors 151, 154, and 155 and the gate insulating layer 140. The data conductors 171, 173a, 173b, 173c, 175a, 175b, and 175c include a plurality of data lines 171 including a first source electrode 173a and a second source electrode 173b, a first drain electrode 175a, a second drain electrode 175b, a third source electrode 173c, and a third drain electrode 175c.

The first gate electrode 124a, the first source electrode 173a, and the first drain electrode 175a form a first thin film transistor Qa together with the semiconductor 154. A channel of the first thin film transistor Qa is formed at the semiconductor portion 154 between the first source electrode 173a and the first drain electrode 175a. Similarly, the second gate electrode 124b, the second source electrode 173b, and the second drain electrode 175b form a second thin film transistor Qb together with the semiconductor 154. A channel of the second thin film transistor Qb is formed at the semiconductor portion 154 between the second source electrode 173b and the second drain electrode 175b. Additionally, the third gate electrode 124c, the third source electrode 173c, and the third drain electrode 175c form a third thin film transistor Qc together with the semiconductor 154. A channel of the third thin film transistor Qc is formed at the semiconductor portion 154 between the third source electrode 173c and the third drain electrode 175c.

According to exemplary embodiments, the structure of the data line 171 includes a width that becomes smaller in a forming region of the third thin film transistor Qc in the vicinity of an extension 175c′ of the third drain electrode 175c. The aforementioned structure of is the data line 171 maintains an interval with adjacent wiring, as well as reduces signal interference. It is contemplated, however, that the aforementioned structure of the data 171 may be additionally or alternatively formed.

A first passivation layer 180 is formed on the data conductors 171, 173a, 173b, 173c, 175a, 175b, and 175c and an exposed portion of the semiconductor 154. The first passivation layer 180 may include any suitable material, e.g., an inorganic insulator, such as, for example, silicon nitride (SiNx), silicon oxide (SiOx), etc.

Color filters 230 and 230′ are formed on the passivation layer 180. Color filters 230 of the same color are formed in adjacent pixels that are adjacent in a vertical direction (e.g., a direction parallel to data line 171). Color filters 230 and 230′ of different colors are formed in adjacent pixels that are adjacent in a horizontal direction (e.g., a direction parallel to gate line 121). It is contemplated that color filters 230 and 230′ may overlap respective portions of the data line 171. The color filters 230 and 230′ may be configured to facilitate the display of at least one color, such one of the primary colors, e.g., red, green, and blue. However, it is also contemplated that the color filters 230 and 230′ may facilitate the display any other suitable color, such as cyan, magenta, yellow, and white colors. It is noted that color filters 230 and 230′ may be collectively referred to as color filter 230.

A light blocking member (or black matrix) 220 is formed on the color filters 230 and 230′. According to exemplary embodiments, the light blocking member 220 may include any suitable material through which light is not transmitted. The light blocking member 220 forms a lattice structure including an opening. As such, a color filter (e.g., color filter 230), a pixel electrode (e.g., pixel electrode 192), and a liquid crystal layer (e.g., liquid crystal layer 3) are positioned at least in the opening of the light block member 220.

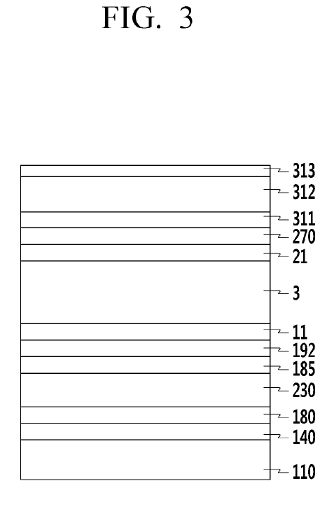

A second passivation layer 185 is disposed on the black matrix 220 and the color filters 230 and 230′. According to exemplary embodiments, the second passivation layer 185 includes any suitable material, such as, for example, an organic insulator. As such, the second passivation layer 185 may also be referred to as an organic passivation layer 185. The second passivation layer 185 may be the organic passivation layer 185 including a refractive index, as will be described in more detail in association with FIGS. 3-5.

According to exemplary embodiments, the second passivation layer 185 is formed of an organic passivation layer, which reduces or removes a step resulting, at least in part, from a thickness difference between the color filters 230 and 230′ and the light blocking member 220.

A first contact hole (or via) 186a and a second contact hole (or via) 186b respectively expose the first drain electrode 175a and an extension 175b′ of the second drain electrode 175b. In this manner, the first contact hole 186a and the second contract hole 186b are formed through the color filter 230, the black matrix 220, and the passivation layers 180 and 185. Further, a third contact hole (or via) 186c exposes the protrusion 134 of the storage voltage line 131 and the extension 175c′ of the third drain electrode 175c. In this manner, the third contact hole 186c is formed through the color filter 230, the light blocking member 220, and the passivation layers 180 and 185.

According to exemplary embodiments, the light blocking member 220 and the color filter 230 include the contact holes 186a, 186b, and 186c extending therethrough. In this manner, the formation (e.g., etching) of the contact holes 186a, 186b, and 186c may be difficult due to material differences between the light blocking member 220 and the color filter 230, as compared to the materials of the passivation layers 180 and 185. As such, the light blocking member 220 and/or the color filter 230 may be removed (e.g., etched) at positions corresponding is to the contact holes 186a, 186b, and 186c before the contact holes 186a, 186b, and 186c are formed.

According to exemplary embodiments, the contact holes 186a, 186b, and 186c may be formed by changing a position of the light blocking member 220 and etching only the color filter 230 and the passivation layers 180 and 185.

The pixel electrode 192, including the first subpixel electrode 192h and the second subpixel electrode 192l, is formed on the second passivation layer 185. The pixel electrode 192 may be made of any suitable material, such as, for example, a transparent conductive material, e.g., aluminum zinc oxide (AZO), gallium zinc oxide (GZO), indium tin oxide (ITO), indium zinc oxide (IZO), etc. It is also contemplated that one or more conductive polymers (ICP) may be utilized, such as, for example, polyaniline, poly(3,4-ethylenedioxythiophene) poly(styrenesulfonate) (PEDOT:PSS), etc.

The first subpixel electrode 192h and the second subpixel electrode 192l are adjacent to each other in a column (or vertical) direction (e.g., a direction parallel to the extension of data line 171). First and second subpixel electrodes 192h and 192l include an entirely quadrangular shape, and a cross stem configured by a transverse stem and a longitudinal stem crossing the transverse stem. Further, the first subpixel electrode 192h and the second subpixel electrode 192l may be divided into four subregions by the transverse stem and the longitudinal stem. In this manner, each subregion may include a plurality of minute branches. While exemplary embodiments are described herein in association with the aforementioned configuration of subpixel electrodes 192h and 192l, it is also contemplated that first and second subpixel electrodes 192h and 192l may be otherwise configured.

According to exemplary embodiments, the minute branches of the first subpixel is electrode 192h and the second subpixel electrode 192l form angles of about 40 degrees to 45 degrees with the gate line 121 or the transverse stem. Further, the minute branches of two adjacent subregions may be perpendicular to each other. In other words, the minute branches of four adjacently disposed subregions may converge (or diverge) from a central portion of a corresponding subpixel, e.g., a central portion where the transverse stem and longitudinal stem cross one another. Further, while not illustrated, a width of each (or some) of the minute branches may become gradually larger (or smaller) and/or intervals between the, or some of the, minute branches 194 may be different from each other.

In exemplary embodiments, the first subpixel electrode 192h and the second subpixel electrode 192l are physically and electrically connected with the first drain electrode 175a and the second drain electrode 175b through the first and second contact holes 186a and 186b. As such, the first and second subpixel electrodes 192h and 192l receive data voltages from the first drain electrode 175a and the second drain electrode 175b, respectively.

A connecting member 194 electrically connects the extension 175c′ of the third drain electrode 175c and the protrusion 134 of the storage voltage line 131 through the third contact hole 186c. As a result, some of the data voltage applied to the second drain electrode 175b may be divided through the third source electrode 173c. As such, the magnitude of a voltage applied to the second subpixel electrode 192l may be smaller than the magnitude of a voltage applied to the first subpixel electrode 192h.

According to exemplary embodiments, an area of the second subpixel electrode 192l may be the same or up to double an area of the first subpixel electrode 192h.

An opening (not shown) may be configured to collect gas discharged from the color filter 230 and an overcoat (not illustrated) covering the corresponding opening with the is same material as the pixel electrode 192 may be formed on the second passivation layer 185.

The opening and the overcoat may be utilized to block gas discharged from the color filter 230, which blocks the gas from being transferred to another element. It is noted that the opening and the overcoat may not be included in exemplary embodiments.

The liquid crystal layer 3 is formed on the second passivation layer 185 and the pixel electrode 192. A space where the liquid crystal layer 3 is positioned is referred to as a microcavity layer. The microcavity layer is supported by an overlying roof layer 312. According to exemplary embodiments, the microcavity layer includes a plurality of microcavities, each microcavity corresponding to a pixel of the liquid crystal display. In this manner, each of the microcavities includes liquid crystal molecules 310, as will become more apparent below.

An alignment layer (not shown) to align liquid crystal molecules 310 may be formed between the microcavity layer and the liquid crystal layer 3. The alignment layer may include any suitable material, such as, for example, polyamic acid, polysiloxane, or polyimide.

The liquid crystal molecules 310 are initially aligned by the alignment layer, and an arrangement direction thereof is changed according to an applied electric field imposed, at least in part, by way of pixel electrode 192. A height (or thickness) of the liquid crystal layer 3 corresponds to a height (or thickness) of the microcavity layer. According to exemplary embodiments, the thickness of the liquid crystal layer 3 may be (or about) 2.0 μm to (or about) 3.6 μm, e.g., 2.5 μm to 3.1 μm, such as 2.7 μm to 2.9 μm.

In exemplary embodiments, a portion of the microcavity layer is opened to form a liquid crystal injection hole 335. As such, liquid crystal molecules 310 may be injected into the microcavity layer by way of a capillary force through the liquid crystal injection hole 335. In is this manner, the alignment layer may also be formed by the capillary force. The liquid crystal injection hole 335 may be sealed by a capping layer (not shown) after the alignment layer and the liquid crystal molecules 310 are injected.

A common electrode 270 is positioned on the microcavity layer and the liquid crystal layer 3. A portion of the structure of the common electrode 270 may be curved (or otherwise extend towards insulation substrate 110) along the microcavity layer so as to be close to (e.g., extend towards) and above the data line 171. Further, the common electrode 270 may not be formed in a portion where the liquid crystal injection hole 335 is formed (e.g., not formed in a region where the transistor is formed) to have an extending structure in a gate line direction (e.g., a horizontal direction).

The common electrode 270 may include any suitable transparent conductive material, such as, for example, AZO, GZO, ITO, IZO, etc. It is also contemplated that the common electrode 270 may be formed from one or more conductive polymers, e.g., polyaniline, PEDOT:PSS, etc. According to exemplary embodiments, the common electrode 270 may serve to generate an electric field together with the pixel electrode 192, and thereby, configured to control an arrangement direction of the liquid crystal molecules 310.

A lower insulating layer 311 is positioned on the common electrode 270. In exemplary embodiments, the lower insulating layer 311 may include any suitable material, such as, for example, an inorganic insulating material, e.g., silicon nitride (SiNx), silicon oxide (SiOx), etc.

The roof layer 312 is formed on the lower insulating layer 311. The roof layer 312 may serve to support a space (microcavity) to be formed between the pixel electrode 192 and the common electrode 270. The roof layer 312, according to exemplary embodiments, may be is formed of an organic insulator, which may exhibit a relatively high refractive index. The organic insulator having a high refractive index is described in more detail in association with FIGS. 3-5.

An upper insulating layer 313 is formed on the roof layer 312. The upper insulating layer 313, according to exemplary embodiments, may be formed of any suitable material, such as, for example, the inorganic insulating material, e.g., SiNx, SiOx, etc.

The lower insulating layer 311, the roof layer 312, and the upper insulating layer 313 may include the liquid crystal injection hole 335 formed at one side thereof (e.g., formed in a portion corresponding to the transistor formation region), to enable liquid crystal to be injected into the microcavity layer. The liquid crystal injection hole 335 may be used even when removing the sacrificial layer (not shown) for forming the microcavity layer.

For instance, the microcavity layer may be formed as follows. A sacrificial layer may be formed with a shape of the microcavity layer. The common electrode 270, the lower insulating layer 311, the roof layer 312, and the upper insulating layer 313 may be formed on the sacrificial layer. The common electrode 270, the lower insulating layer 311, the roof layer 312, and the upper insulating layer 313 may be patterned (e.g., etched) to form the liquid crystal injection hole 335 exposing the sacrificial layer. In this manner, the exposed sacrificial layer may be removed. The liquid crystal molecules 310 may be injected through the liquid crystal injection hole 335 to form the liquid crystal layer 3. It is noted that, in the thin film transistor formation region where the liquid crystal injection hole 335 is positioned, and after the lower insulating layer 311 and the upper insulating layer 313 are deposited and the roof layer 312 is formed (but not formed in the thin film transistor formation region), only the lower insulating layer 311 and the upper insulating layer 313 are removed in the thin film transistor formation region to form the liquid crystal injection hole 335.

According to exemplary embodiments, the roof layer 312, the upper insulating layer 313, and the lower insulating layer 311 are patterned (e.g., etched) together in the thin film transistor formation region, thereby, forming the liquid crystal injection hole 335. The liquid crystal injection hole 335 may be sealed by the capping layer (not illustrated).

According to exemplary embodiments, the lower insulating layer 311 and the upper insulating layer 313 may be omitted.

Corresponding polarizers (not shown) are respectively positioned below the insulation substrate 110 and above the upper insulating layer 313. The polarizers may include a polarization element for polarization and a triacetylcellulose (TAC) layer for ensuring durability. According to exemplary embodiments, directions of the transmissive axes of the polarizer disposed on the upper insulating layer 313 and the polarizer disposed below the insulation substrate 110 may be perpendicular or parallel to each other.

Transmission characteristics of a liquid crystal display, according to exemplary embodiments, will be described in association with FIGS. 3-5.

FIG. 3 is a schematic cross-sectional view of a liquid crystal display, according to exemplary embodiments. It is noted that the cross-sectional view of FIG. 3 only illustrates layers related to transmittance of light in exemplary embodiments of FIGS. 1 and 2.

As seen in FIG. 3, the liquid crystal display passes light through the insulation substrate 110, the gate insulating layer 140, the first passivation layer 180, the color filter 230, the second passivation layer 185, the pixel electrode 192, a lower alignment layer 11, the liquid crystal layer 3, an upper alignment layer 21, the common electrode 270, the lower insulating layer 311, the roof layer 312, and the upper insulating layer 313. Once the light propagates through each of the above-noted layers, the light may be transmitted to an observer in association with the display of images. According to exemplary embodiments, the insulation substrate 110 may have a refractive index of about 1.5, the gate insulating layer 140 may have a refractive index of about 1.86, the first passivation layer 180 may have a refractive index of about 1.86, the color filter 230 may have a refractive index of about 1.6, the pixel electrode 192 may have a dielectric ratio (or relative permittivity) of about 2.05, the lower alignment layer 11 and the upper alignment layer 21 may respectively have a refractive index of about 1.6, the common electrode 270 may have a refractive index of about 1.83, and the lower insulating layer 311 and the upper insulating layer 313 may have a refractive index of about 1.86.

According to exemplary embodiments, the second passivation layer 185 and the roof layer 312 may be organic layers having a refractive index of about 1.54. It is noted that the refractive index of these organic layers 185 and 312 is lower than the refractive index of other layers, such that the transmittance is reduced by reflection of light at an interface between layers of higher and lower refractive indices. In general, utilization of one organic layer may cause the transmittance to be reduced by about 3%.

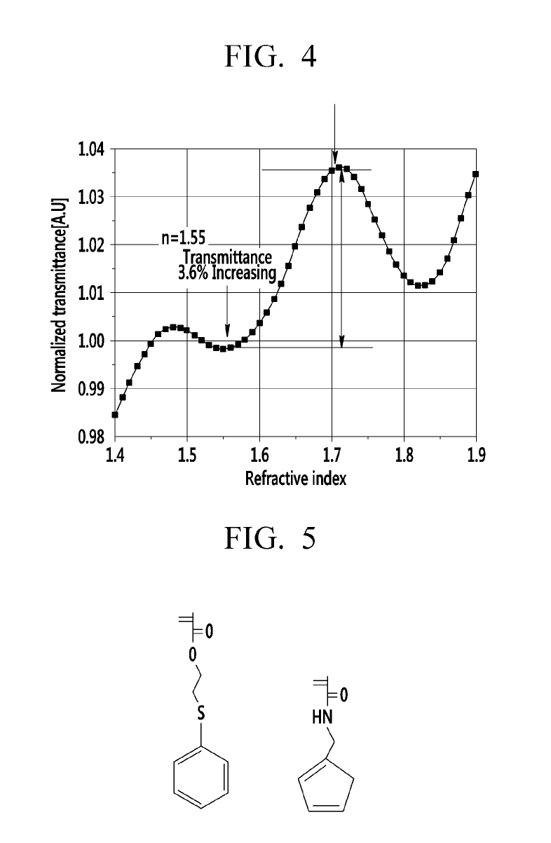

According to exemplary embodiments, however, at least one of the two organic layers (i.e., at least one of the second passivation layer 185 and the roof layer 312) is formed of the organic layer having a relatively high refractive index to decrease the amount of reflection of light at the interface of the organic layers with the other layers, thereby, improving the transmittance of the display device. An optical characteristic at an interface between an organic layer and an inorganic insulating layer (e.g., SiNx, SiOx, etc.) is described in more detail in association with FIG. 4.

FIG. 4 is a graph comparing normalized transmittance with refractive index, according to exemplary embodiments. It is noted that the normalized transmission characteristic is illustrated in FIG. 4 is illustrated based on varying the refractive index of an organic layer when light of the wavelength of 550 nm is utilized. As such, the x-axis represents the refractive index of the organic layer and the y-axis represents the normalized transmittance.

As seen in FIG. 4, an interface reflection characteristic with the inorganic insulating layer of SiNx is at a minimum when the refractive index of the organic layer is 1.7. In this manner, the normalized transmittance is relatively large. Accordingly, since the organic layers noted above have a refractive index of about 1.54, a refractive index range of an organic layer associated with higher transmittance than the above-noted organic layers is greater than 1.6.

As seen in FIG. 4, even though the transmittance is decreased to a minimum value near where the refractive index of the organic layer is about 1.8, the normalized transmittance is still improved as compared to the organic layers having the refractive index of 1.54. It is noted that, while the graph of FIG. 4 only illustrates the normalized transmission in comparison to the refractive index varying up to 1.9, it is noted that the relatively higher normalized transmittance may be obtained up to the refractive index of 2.0 based on the characteristics of the graph as compared to the organic layers noted above. Accordingly, the refractive index range of the organic layers to improve the transmittance may be configured between 1.6 and 2.0, e.g., at about 1.7125. Accordingly, when at least one of the organic layers 185 or 312 exhibits a refractive index of 1.6 to 2.0, the reflective interface characteristic (and, thereby, normalized transmittance) with an inorganic insulating layer made of, for instance, SiNx having a refractive index of about 1.86, is improved.

Adverting back to FIG. 3, the lower insulating layer 311 and the upper insulating layer 313 (i.e., inorganic insulating layers) are formed on and under the roof layer 312 (i.e., an is organic layer). As such, if the roof layer 312 has the refractive index of 1.6 to 2.0, the transmission characteristic may be improved at the interface between the lower insulating layer 311 and the roof layer 312 and at the interface between the upper insulating layer 313 and the roof layer 312, thereby, enabling improvement in the transmittance of the liquid crystal display according to exemplary embodiments. To this end, it is also contemplated that, since the second passivation layer 185 is also an organic layer, it too may be formed of an organic material exhibiting an refractive index of 1.6 to 2.0, which may also improve the transmission characteristic of the liquid crystal display according to exemplary embodiments.

Accordingly, it is noted that since conventional organic materials from which layers 312 and/or 185 may be formed typically exhibit a refractive index of 1.54, an additive having a relatively higher refractive index may be added to the organic materials to increase the refractive index to 1.6 to 2.0.

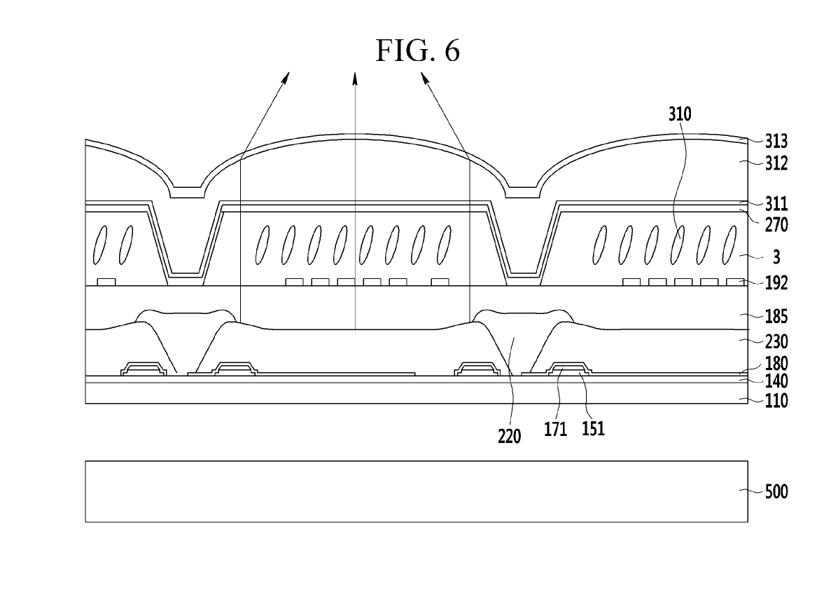

According to exemplary embodiments, to form an organic layer of a relatively higher refractive index, the additive of a relatively higher refractive index is mixed with an acrylate. As the additive of the relatively higher refractive index, an organic/inorganic hybrid sol-gel or nano-sized particles dispersed in a solution may be used. It is noted, however, that such materials may cause a haze to be generated in the organic layer or roughness of the surface may be reduced based on the additive used. The acrylate of the solution includes an acryl, and the acryl may exhibit a refractive index of 1.49 to 1.53. As such, an additive of a relatively higher refractive index might include a ceramic sol or a relatively higher refractive index monomer. It is noted that the ceramic sol might include, for example, silicon dioxide (SiO₂), titanium dioxide (TiO₂), aluminum oxide (Al₂O₃), and zirconium dioxide (ZrO₂). Among them, TiO₂ has a refractive index of about 2.5 to 2.7, and ZrO₂ has a refractive index of about 2.13. A is relatively higher refractive index monomer might exhibit a refractive index of about 1.5 to 1.8. Exemplary chemical formulas of such monomers are illustrated in FIG. 5. However, it is contemplated that any suitable monomer may be used.

According to exemplary embodiments, the transmittance of the liquid crystal display having the microcavity layer may be improved when at least one of the organic layers 185 and 312 are formed exhibiting a refractive index of 1.6 to 2.0.

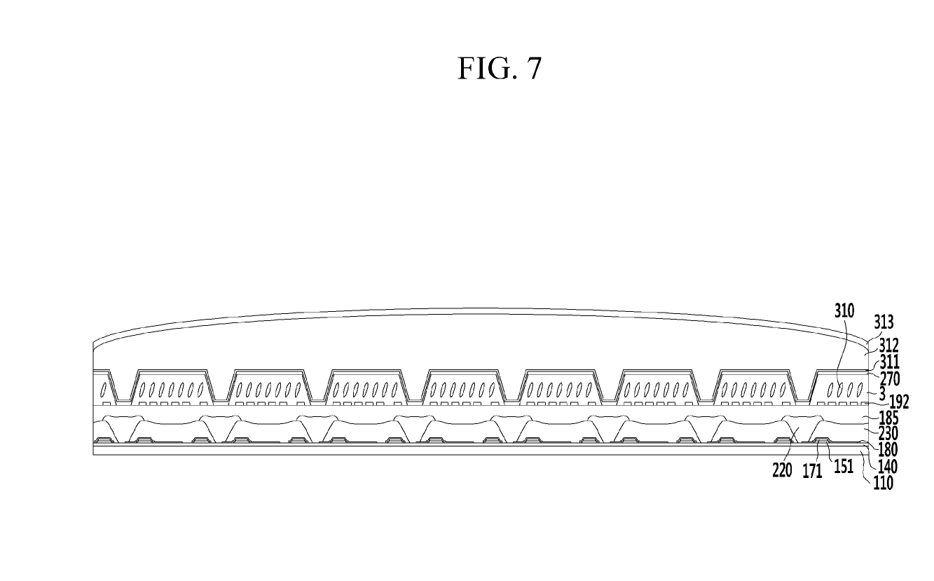

According to exemplary embodiments, a convex pattern may be formed in the roof layer 312 to change the optical characteristics of the liquid crystal display, as will be described in more detail in association with FIGS. 6-10.

FIG. 6 is a cross-sectional view of a liquid crystal display, according to exemplary embodiments. It is noted that the exemplary configuration illustrated in FIG. 6 may be utilized to improve a light collecting effect of the associated liquid crystal display device. Further, to avoid obscuring exemplary embodiments described herein, only differences between the cross-sections of FIGS. 2 and 6 are described.

As seen in FIG. 6, the liquid crystal display may include a backlight unit 500. According to exemplary embodiments, the backlight unit 500 may include, while not illustrated, a light source, a light guide, a reflection sheet, a diffuser sheet, and a luminance improvement film.

According to exemplary embodiments, the liquid crystal layer 3 is positioned in the microcavity layer, and a common electrode 270, a lower insulating layer 311, a roof layer 312, and an upper insulating layer 313 are positioned on the liquid crystal layer 3. As seen in FIG. 6, the roof layer 312 includes a convex pattern, such that each liquid crystal region is respectively associated with a corresponding convex formation of the convex pattern. For instance, the convex pattern may closely resemble a lenticular pattern.

According to exemplary embodiments, each liquid crystal region may represent one pixel, such that a convex portion of the convex pattern of the roof layer 312 is formed in association with each pixel of the display device. In other words, the width of each convex portion of the convex pattern may be configured to corresponding to the width of a pixel. To this end, it is noted that the convex portion of the convex pattern extends, not only in the horizontal direction (e.g., the gate line direction), but also in the vertical direction (e.g., the data line direction), such that the convex portion forms a spherical cap.

According to exemplary embodiments, the convex pattern of the roof layer 312 shown in FIG. 6 may enable a light collecting characteristic, such that transmitted light is not spread, but is progressed in a front surface of the liquid crystal display. In this manner, the luminance of the front surface may be increased.

In exemplary embodiments, the data lines 171 may be arranged as a pair of data lines 171 disposed at respective sides of the light blocking member 220. As such, it is contemplated that the lower structure of the liquid crystal display (e.g., the portion of the liquid crystal display disposed below liquid crystal layer 3) may also be variously configured. Further, the structure of the microcavity layer includes a tapered structure in FIGS. 2 and 6; however, it is contemplated that a reverse tapered structure may be utilized. To this end, the common electrode 270 is formed based on the curved structure of the microcavity layer; however, it is contemplated that the common electrode 270 may be formed with a horizontal (or planar) structure, i.e., formed without the curved structure of the microcavity layer.

While not illustrated, it is also contemplated that corresponding polarizers may be positioned below the insulation substrate 110 and above the upper insulating layer 313. In this manner, while the convex pattern has been described as being formed in association with the roof layer 312, it is also contemplated that the upper polarizer of the two polarizers may be formed including the convex pattern instead of the roof layer 312. To this end, the upper insulating layer 313 or the lower insulating layer 311 may be omitted.

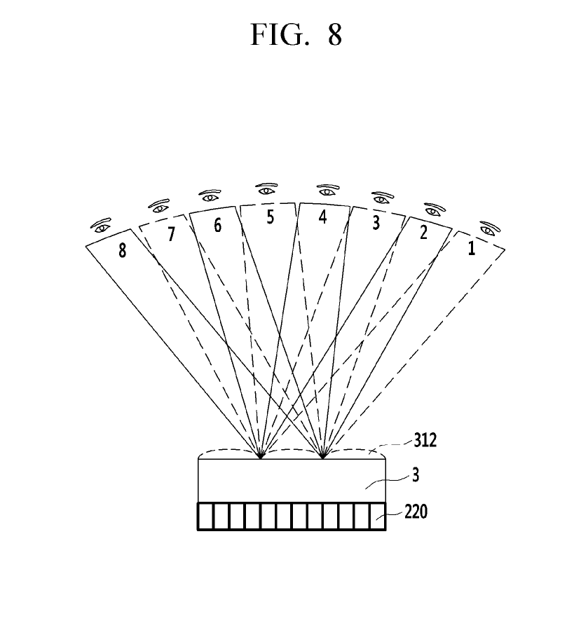

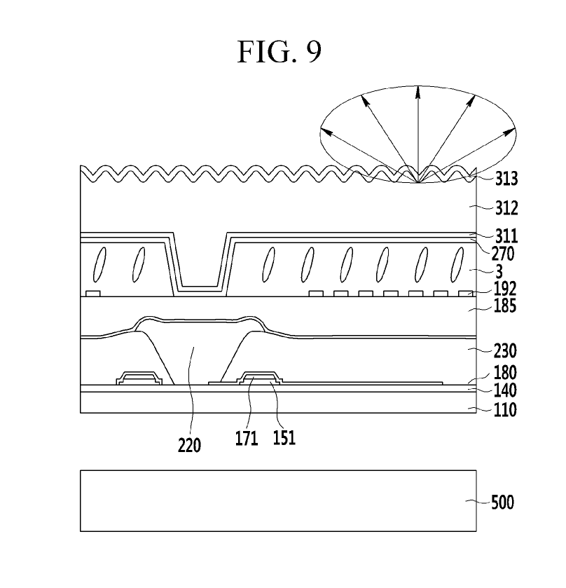

According to exemplary embodiments, the roof layer 312 may be formed including the convex pattern exhibiting a convex portion associated with a plurality of pixels, as will be described in more detail in association with FIGS. 7 and 8.

FIG. 7 is a cross-sectional view of a liquid crystal display, according to exemplary embodiments. FIG. 8 illustrates various viewing points of the liquid crystal display of FIG. 7. It is noted that the exemplary configuration illustrated in FIGS. 7 and 8 may be utilized to enable multiple viewing points of the liquid crystal display device. Further, to avoid obscuring exemplary embodiments described herein, only differences between the cross-sections of FIGS. 2 and 7 are described.

As shown in FIG. 7, the convex pattern may be formed in the roof layer 312, such that each convex portion horizontally covers a plurality of (e.g., eight) liquid crystal regions. That is, one convex portion of the convex pattern is formed to correspond to, for instance, eight horizontally disposed pixels. It is contemplated, however, that any suitable number of horizontally disposed pixels may be associated with each convex portion. To this end, it is noted that the convex portion of the convex pattern extends, not only in the horizontal direction (e.g., the gate line direction), but also in the vertical direction (e.g., the data line direction), such that the convex portion forms a spherical cap over a plurality of horizontally and vertically disposed pixels.

According to exemplary embodiments, the above-noted convex pattern changes is the progressing direction of transmitted light from the liquid crystal display, such as illustrated in FIG. 8. Namely, the above-noted convex pattern of FIG. 7 enables eight viewing points; however, depending on the number of pixels associated with each convex portion, the number of viewing points may be correspondingly affected. To this end, the various viewing points enable different images to be recognized based on the viewing point from which an observer perceives the transmitted light. To this end, the difference in the position of the eyes of an observer enables the different images to be autonomically perceived as a stereoscopic (e.g., three-dimensional) image. As such, the liquid crystal display of FIG. 7 enables a stereoscopic image to be perceived without a separate structure, such as, for example, a lenticular lens, etc., to be used.

According to exemplary embodiments, one convex portion of the convex pattern may be formed to cover three to twenty horizontally disposed pixels.

To reduce a moiré effect (i.e., light interference patterns) when displaying stereoscopic images, the convex pattern may be extended in a direction slightly inclined with respect to the vertical direction.

While not illustrated, it is also contemplated that corresponding polarizers may be positioned below the insulation substrate 110 and above the upper insulating layer 313. In this manner, while the convex pattern has been described as being formed in association with the roof layer 312, it is also contemplated that the upper polarizer of the two polarizers may be formed including the convex pattern instead of the roof layer 312. To this end, the upper insulating layer 313 or the lower insulating layer 311 may be omitted.

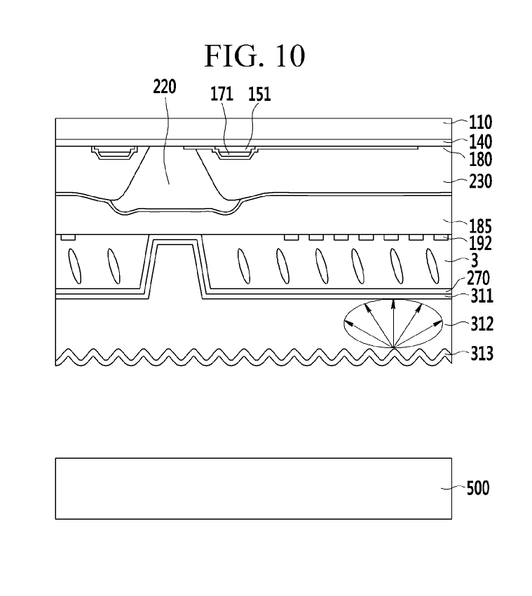

According to exemplary embodiments, a size of the convex pattern (i.e., respective undulations of the convex pattern) may be minute as compared to the plurality of microcavities of the microcavity layer, as will be described in more detail in association with FIGS. 9 and 10.

FIG. 9 and FIG. 10 are cross-sectional views of a liquid crystal display, according to exemplary embodiments. To avoid obscuring exemplary embodiments described herein, only differences between the cross-sections of FIGS. 2, 9, and 10 are described.

As shown in FIG. 9, the convex pattern of the roof layer 312 is minutely formed as compared to the plurality of microcavities of the microcavity layer. That is, the convex pattern includes a plurality of undulations, such that each microcavity of the microcavity layer is disposed in association with a respective plurality of the plurality of undulations of the convex pattern. In this manner, the convex pattern may be referred to as an embossing pattern. The embossing pattern may be formed with a pitch of 2 to 50 μm, e.g., 15 to 37 μm, such as 20 to 32 μm. In other words, respective undulations of the convex pattern may be spaced apart by 2 to 50 μm, e.g., 15 to 37 μm, such as 20 to 32 μm. As a result, incident light may be scattered by the roof layer 312 including the minute convex pattern.

According to exemplary embodiments, the backlight unit 500 may be positioned under the insulation substrate 110, and thereby, configured to provide light to the insulation substrate 110. As a result, the light emitted from the backlight unit 500 is transmitted to the embossing pattern through the liquid crystal layer 3 and is scattered to be emitted towards an observer. According to exemplary embodiments, it is contemplated that a polarizer (not shown) may be formed under the insulation substrate 110 and on the upper insulating layer 313. In general, a non-reflection layer may be disposed on the upper insulating layer 313, such as an anti-glare layer. In exemplary embodiments, however, since the light is scattered by the minute embossing pattern, an additional non-reflection layer may be omitted.

According to exemplary embodiments, the above-noted polarizers may be respectively disposed under the insulation substrate 110 and on the upper insulating layer 313. In this manner, while the convex pattern has been described as being formed in association with the roof layer 312, it is also contemplated that the upper polarizer of the two polarizers may be formed including the convex pattern instead of the roof layer 312. To this end, the upper insulating layer 313 or the lower insulating layer 311 may be omitted.

Adverting to FIG. 10, the backlight unit 500 faces the embossing pattern of the roof layer 312. That is, the roof layer 312 is disposed between the backlight unit 500 and the insulation substrate. As such, the light provided from the backlight unit 500 is provided to the roof layer 312 before being provided to the liquid crystal layer 3. In this manner, the light provided from the backlight unit 500 is transmitted through the roof layer 312, the liquid crystal layer 3, and through the insulation substrate 110 to be emitted toward an observer. The embossing pattern may be formed with the pitch of 2 to 50 μm, e.g., 15 to 37 μm, such as 20 to 32 μm. In other words, respective undulations of the convex pattern may be spaced apart by 2 to 50 μm, e.g., 15 to 37 μm, such as 20 to 32 μm.

According to exemplary embodiments, the convex pattern formed includes the minute embossing pattern, such that light propagating into the liquid crystal layer 3 is scattered by the embossing pattern and then propagates through the liquid crystal layer 3. This provides a similar effect as a conventional diffusing film typically used to uniformly provide light from the backlight unit 500 without a difference for each region. As such, according to exemplary embodiments, the backlight unit 500 may omit such a conventional diffusing film.

While not illustrated, it is also contemplated that corresponding polarizers may be positioned below insulation substrate 110 and above upper insulating layer 313. In this manner, is while the convex pattern has been described as being formed in association with the roof layer 312, it is also contemplated that the upper polarizer of the two polarizers may be formed including the convex pattern instead of the roof layer 312. To this end, the upper insulating layer 313 or the lower insulating layer 311 may be omitted.

According to exemplary embodiments, by forming the convex pattern in the roof layer 312, the optical characteristics of the liquid crystal display may be changed. Furthermore, as shown in FIGS. 3-5, the roof layer 312 may include an organic material and be formed exhibiting a relatively higher refractive index (e.g., a refractive index of 1.6 to 2.0), and thereby, improve the transmittance of the display device. Moreover, the second passivation layer 185 may include the organic material and be formed exhibiting the relatively higher refractive index to further enhance the transmittance of the display device.

According to exemplary embodiments, the convex pattern of the roof layer 312 may be formed via one or more exposure and developing processes when the roof layer 312 is formed including the organic material. Alternatively, the convex pattern may be formed in the roof layer 312 after injecting the liquid crystal molecules into the plurality of microcavities.

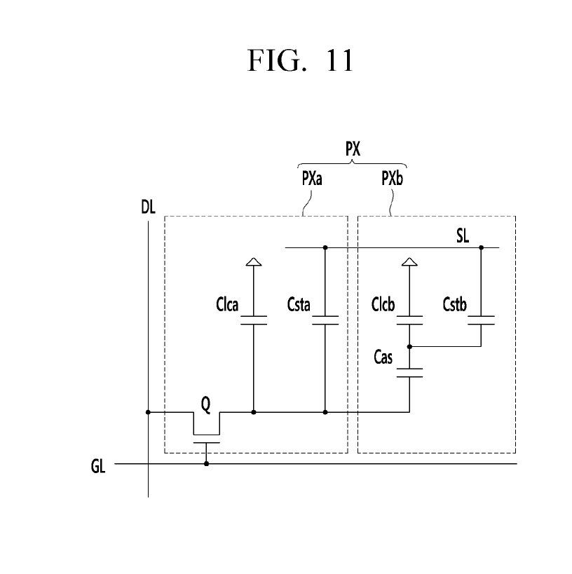

According to exemplary embodiments, the pixel structure of the liquid crystal display may be modified, such as described in association with FIGS. 11-14. It is noted, however, that any other suitable pixel structure may be utilized.

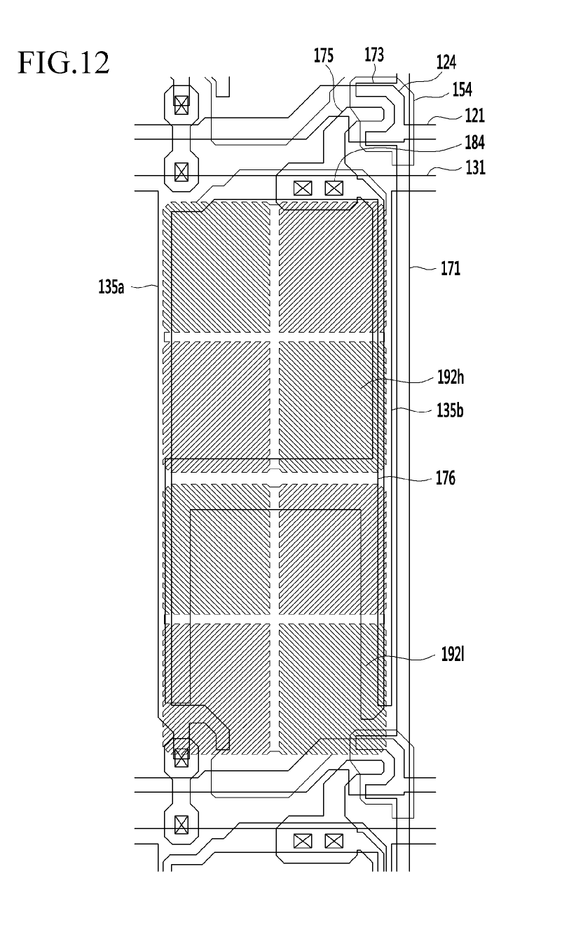

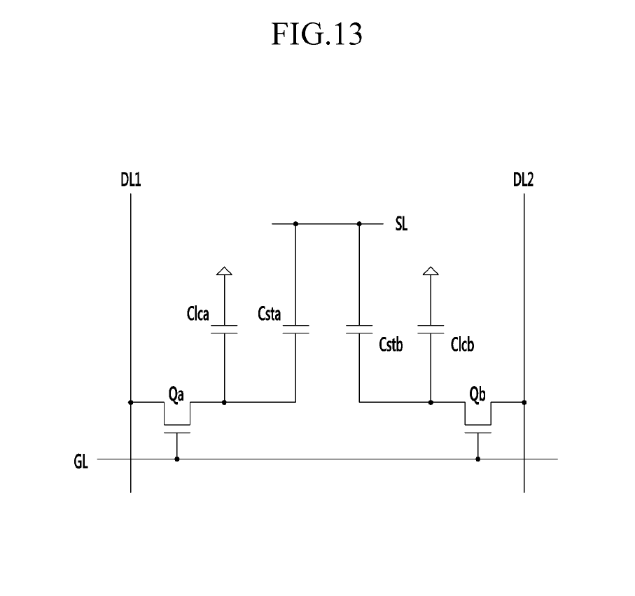

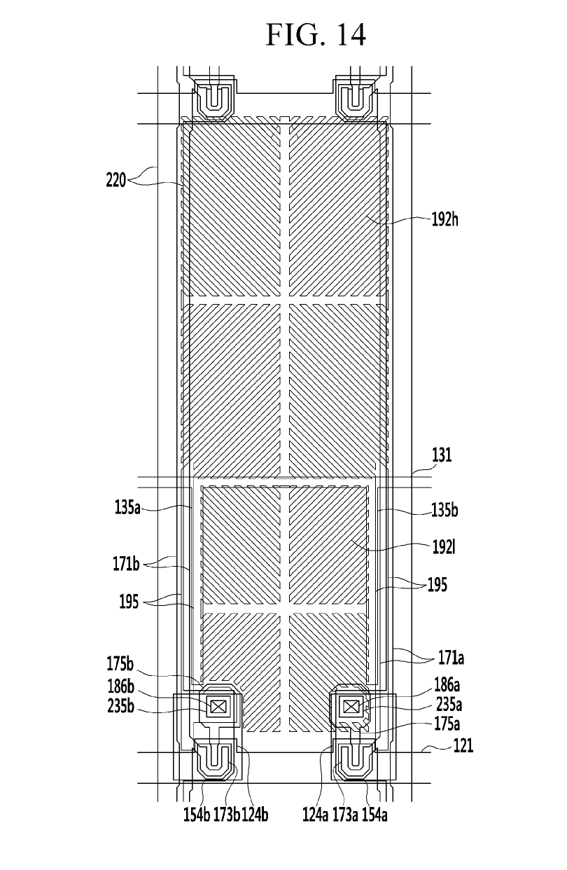

FIGS. 11 and 13 are circuit diagrams of liquid crystal displays including modified pixel structures, according exemplary embodiments. FIGS. 12 and 14 are plan views of the liquid crystal displays of FIGS. 11 and 13.

As seen in FIGS. 11 and 12, two subpixels PXa and PXb receive a data voltage from one transistor Q, and are coupled by a storage capacitor Cas, as will become more apparent is below.

According to exemplary embodiments, the liquid crystal display includes a plurality of signal lines, including a plurality of gate lines GL, a plurality of data lines DL, and a plurality of storage voltage lines SL, with a plurality of pixels PX connected thereto. Each pixel PX includes a pair of subpixels, e.g., a first subpixel PXa and a second subpixel PXb. The first subpixel PXa includes the first subpixel electrode (192h of FIG. 12), and the second subpixel PXb includes the second subpixel electrode (192l of FIG. 12).

The liquid crystal display further includes the switching element Q connected to the gate line GL and the data line DL. The first liquid crystal capacitor Clca and the first storage capacitor Csta are connected to the switching element Q and are formed in the first subpixel PXa. The second liquid crystal capacitor Clcb and the second storage capacitor Cstb are connected to the switching element Q and are formed in the second subpixel PXb. An assistance capacitor Cas is formed between the switching element Q and the second liquid crystal capacitor Clcb.

The switching element Q is a three-terminal element, such as a thin film transistor, disposed on the insulating substrate 110. The switching element Q includes a control terminal connected to a gate line (GL), an input terminal connected to a data line (DL), and an output terminal connected to the first liquid crystal capacitor Clca, the first storage capacitor Csta, and the assistance capacitor Cas.

One terminal of the assistance capacitor Cas is connected to the output terminal of the switching element Q, and the other terminal is connected to the second liquid crystal capacitor Clcb and the second storage capacitor Cstb.

The charging voltage of the second liquid crystal capacitor Clcb is lower than the is charging voltage of the first liquid crystal capacitor Clca due to the assistance capacitor Cas, such that the lateral visibility of the liquid crystal display may be improved.

As shown in FIG. 12, a plurality of gate conductors, including a plurality of gate lines 121 and a plurality of storage voltage lines 131, are formed on the insulation substrate (not shown) made of any suitable material, such as, for example, transparent glass or plastic.

The gate line 121 transmits gate signals and extends in a substantially horizontal direction. Each gate line 121 includes a plurality of gate electrodes 124 protruding upward.

The storage electrode line 131 receives a predetermined voltage, and may extend parallel to the gate line 121. Each storage voltage line 131 is positioned between two adjacent gate lines 121. The storage voltage line 131 includes the storage electrodes 135a and 135b extending downward. However, it is contemplated that the shape and arrangement of the storage voltage lines 131 and the storage electrodes 135a and 135b may be any suitable shape and/or configuration.

The gate insulating layer (not shown) is formed on the gate conductors 121 and 131. A semiconductor 154 is formed on the gate insulating layer. The semiconductor 154 is also positioned on the gate electrode 124.

The data conductor, including a plurality of data lines 171 and drain electrodes 175, is formed on the semiconductor 154 and the gate insulating layer.

The data lines 171 transmit the data signals and extend in the vertical direction, and thereby, intersect the gate lines 121 and the storage voltage lines 131. Each data line 171 includes a source electrode 173 which extends toward the gate electrode 124.

The drain electrode 175 is separated from the data line 171, and includes a bar-shaped end facing the source electrode 173 with respect to the gate electrode 124. The bar-shaped end is partially surrounded by the source electrode 173, which is curved.

The other end of the drain electrode 175 extends substantially parallel to the data line 171, and thereby, is formed through the first subpixel PXa and the second subpixel PXb. The portion formed in the second subpixel PXb is referred to as an auxiliary electrode 176.

The passivation layer (not shown) is formed on the data conductors 171 and 175 and the semiconductor 154. The passivation layer is made of the organic insulator and has a flat (or planar) surface.

While not illustrated, a color filter may be formed under the passivation layer.

A plurality of pixel electrodes 192 are formed on the passivation layer. Each pixel electrode 192 includes the first subpixel electrode 192h and the second subpixel electrode 192l formed at a predetermined interval.

The first subpixel electrode 192h and the second subpixel electrode 192l respectively include a stem with a crossed shape positioned at a center thereof, and a plurality of minute branch electrodes protruded from the partial plate electrodes in, for example, an oblique direction.

The first subpixel electrode 192h includes a first stem and a plurality of first minute branch electrodes, and is connected to the wide end portion of the drain electrode 175 by a connection extending outside the square (or quadrilateral) region of the first subpixel electrode 192h. A plurality of the first minute branch electrodes form an angle of 45 degrees with respect to the gate line 121 or the data line 171.

The second subpixel electrode 192l includes a second stem and a plurality of second minute branch electrodes, and overlaps the auxiliary electrode 176, and thereby, forms the assistance capacitor Cas. A plurality of the second minute branch electrodes form an angle is of 45 degrees with respect to the gate line 121 or the data line 171.

According to exemplary embodiments, the first and second subpixel electrodes 192h and 192l form the first and second liquid crystal capacitors Clca and Clcb along with the common electrode 270 of the upper panel, with the liquid crystal layer 3 disposed therebetween. In this manner, the first and second liquid crystal capacitors Clca and Clcb are configured to maintain the applied voltage after the thin film transistor (Q of FIG. 11) is turned off.

The first and second subpixel electrodes 192h and 192l overlap the storage electrodes 135a and 135b to form the first and second storage capacitors Csta and Cstb, and thereby, reinforce the voltage storage capacity of the first and second liquid crystal capacitors Clca and Clcb.

According to exemplary embodiments, the auxiliary electrode 176 is extended from the drain electrode 175, but may be alternatively formed. For instance, the auxiliary electrode 176 may be separated from the drain electrode 175. The passivation layer includes a contact hole 184 formed on the first subpixel electrode 192h, and the auxiliary electrode 176 may be connected to the first subpixel electrode 192h through the contact hole 184 and may overlap the second subpixel electrode 192l.

The liquid crystal layer 3 is formed on the second passivation layer 185 and the pixel electrode 192. The space where the liquid crystal layer 3 is positioned is referred to as a microcavity layer. The microcavity layer is supported by the overlying roof layer 312. The microcavity layer includes a plurality of microcavities including liquid crystal molecules 310 disposed therein.

An alignment layer (not shown) to align the liquid crystal molecules 310 may be formed between the microcavity layer and the liquid crystal layer 3.

The liquid crystal molecules 310 are initially aligned by the alignment layer, and the alignment direction may be changed based on an applied electric field.

In exemplary embodiments, a portion of the microcavity layer may be opened to forms a liquid crystal injection hole 335. As such, the liquid crystal molecules 310 may be injected into the microcavity layer by way of a capillary force through the liquid crystal injection hole 335. It is also noted that the alignment layer may be formed by the capillary force. The liquid crystal injection hole 335 may be sealed by a capping layer (not shown) after the alignment layer and the liquid crystal molecules 310 are injected into the microcavities.

The common electrode 270 is positioned on the microcavity layer and the liquid crystal layer 3. A portion of the structure of the common electrode 270 may be curved (or otherwise extend towards the insulation substrate) along the microcavity layer so as to be above and close to (e.g., extend towards) the data line 171. Further, the common electrode 270 may not be formed in a portion where the liquid crystal injection hole 335 is formed (e.g., not formed in a region where the transistor is formed) to have an extending structure in a gate line direction (e.g., the horizontal direction).

The common electrode 270 may include any suitable transparent conductive material, such as AZO, GZO, ITO, IZO, etc. It is also contemplated that the common electrode 270 may be formed from one or more conductive polymers, e.g., polyaniline, PEDOT:PSS, etc. According to exemplary embodiments, the common electrode 270 may serve to generate an electric field together with the pixel electrode 192, and thereby, configured to control an arrangement direction of the liquid crystal molecules 310.

The lower insulating layer 311 is positioned on the common electrode 270. In exemplary embodiments, the lower insulating layer 311 may include any suitable material, such as, for example, an inorganic insulating material, e.g., silicon nitride (SiNx), silicon oxide (SiOx), etc.

The roof layer 312 is formed on the lower insulating layer 311. The roof layer 312 may serve to support a space (microcavity) to be formed between the pixel electrode 192 and the common electrode 270. The roof layer 312, according to exemplary embodiments, is formed of an organic insulator, such as previously described. In this manner, the roof layer 312 may exhibit a relatively higher refractive index than the other layers of the display device.

The upper insulating layer 313 is formed on the roof layer 312. The upper insulating layer 313 may be formed of any suitable material, such as, for example, the inorganic insulating material, e.g., silicon nitride (SiNx), silicon oxide (SiOx), etc.

The lower insulating layer 311, the roof layer 312, and the upper insulating layer 313 may include the liquid crystal injection hole 335 formed at one side thereof (e.g., formed in a portion corresponding to transistor formation region), to enable liquid crystal to be injected into the microcavity layer. The liquid crystal injection hole 335 may be used even when removing the sacrificial layer (not shown) for forming the microcavity layer.

Corresponding polarizers (not illustrated) are respectively positioned below the insulation substrate 110 and above the upper insulating layer 313. The polarizers may include a polarization element for polarization and a triacetylcellulose (TAC) layer for ensuring durability. According to exemplary embodiments, directions of transmissive axes of the polarizer disposed on the upper insulating layer 313 and the polarizer disposed below the insulation substrate 110 may be perpendicular or parallel to each other.

Furthermore, the roof layer 312 may include the convex pattern, such as described in association with one or more of FIGS. 6-10.

According to exemplary embodiments, subpixels PXa and PXb may be configured to receive different data voltages from the transistors Qa and Qb, as will be described in more detail in association with FIGS. 13 and 14.

Referring to FIGS. 13 and 14, a liquid crystal display includes a lower panel (illustrated in FIG. 14), a microcavity layer (not shown) formed thereon, and a liquid crystal layer (not shown) positioned in the microcavity layer.

A plurality of gate lines 121 and a plurality of storage voltage lines 131 and 135 are formed on an insulation substrate (not shown).

The gate lines 121 transmit the gate signal and mainly extend in the horizontal direction. Each gate line 121 includes a plurality of first and second gate electrodes 124a and 124b protruding upward.

The storage electrode lines include a stem 131 substantially parallel to the gate lines 121 and a plurality of storage electrodes 135a and 135b extended therefrom.

According to exemplary embodiments, the shape and arrangement of the storage electrode lines 131 and 135 may be provided in any suitable manner.

The gate insulating layer 140 is formed on the gate lines 121 and the storage voltage lines 131 and 135, and a plurality of semiconductors 154a and 154b made of, for example, amorphous or crystalline silicon, are formed on the gate insulating layer 140.

A plurality of pairs of ohmic contacts (not shown) are formed on the semiconductors 154a and 154b, and the ohmic contacts may be made of a material, such as, for example, n+ hydrogenated amorphous silicon, in which an n-type impurity, such as, for instance, phosphorus is doped with a high concentration, or of silicide.

A plurality of pairs of data lines 171a and 171b and a plurality of pairs of the first and second drain electrodes 175a and 175b are formed on the ohmic contacts and the gate insulating layer 140.

The data lines 171a and 171b transfer a data signal and mainly extend in a vertical direction, and thereby, intersect the gate lines 121 and the stem of the storage electrode lines 131. The data lines 171a and 171b include first and second source electrodes 173a and 173b that are curved with a “U” shape and extend toward the first and second gate electrodes 124a and 124b.

The first and second source electrodes 173a and 173b respectively face the first and second drain electrodes 175a and 175b with respect to the first and second gate electrodes 124a and 124b.

The first and second drain electrodes 175a and 175b start from one end enclosed by the first and second source electrodes 173a and 173b and are extended upward, and the other end thereof may have a wide area portion for connection to another layer. It is contemplated, however, that the shapes and arrangements of the first and second drain electrodes 175a and 175b and the data lines 171a and 171b may be modified in any suitable manner.

The first and second gate electrodes 124a and 124b, the first and second source electrodes 173a and 173b, and the first and second drain electrodes 175a and 175b respectively form first and second thin film transistors Qa and Qb along with the first and second semiconductors 154a and 154b. The channels of the first and second thin film transistors Qa and Qb are respectively formed in the first and second semiconductors 154a and 154b between the first and second source electrodes 173a and 173b and the first and second drain electrodes 175a and 175b.

The ohmic contacts are disposed between the underlying semiconductors 154a and 154b, and the overlying data lines 171a and 171b and drain electrodes 175a and 175b. In this manner, the ohmic contracts reduce contact resistance between the underlying is semiconductors 154a and 154b and the overlying data lines 171a and 171b and drain electrodes 175a and 175b. The semiconductors 154a and 154b have a portion that is exposed without being covered by the data lines 171a and 171b and the drain electrodes 175a and 175b, and a portion between the source electrodes 173a and 173b and the drain electrodes 175a and 175b.

The passivation layer is formed on the data lines 171a and 171b, the drain electrodes 175a and 175b, and the exposed semiconductors 154a and 154b. The passivation layer may be made of any suitable material, such as the above-noted organic insulator. To this end, the passivation layer may have a flat (or planar) surface.

While not illustrated, a plurality of color filters may be formed under the passivation layer. The passivation layer has contact holes 186a and 186b, and the color filters have contact holes 235a and 235b. These contact holes 186a, 186b, 235a and 235b expose the drain electrodes 175a and 175b. The pixel electrode 192 is directly connected to the drain electrodes 175a and 175b through the contact holes 186a, 186b, 235a and 235b.

A plurality of pixel electrodes 192 are formed on the passivation layer. Each pixel electrode 192 includes the first subpixel electrode 192h and the second subpixel electrode 192l formed at predetermined intervals.

The first subpixel electrode 192h and the second subpixel electrode 192l respectively include the stem with the crossed shape positioned at a center thereof, and a plurality of minute branch electrodes protruded from the partial plate electrodes in, for example, an oblique direction.

The first subpixel electrode 192h includes a first stem and a plurality of first minute branch electrodes. The first subpixel electrode 192h is connected to the first drain electrode 175a by a connection extending outside the region where the first subpixel electrode 192h is formed. The plurality of the first minute branch electrodes form an angle of 45 degrees with respect to the gate line 121 or the data line 171.

The second subpixel electrode 192l includes a second stem and a plurality of second minute branch electrodes. The second subpixel electrode 192l is connected to the second drain electrode 175b by a connection extending outside the region where the second subpixel electrode 192l is formed. A plurality of the second minute branch electrodes form an angle of 45 degrees with respect to the gate line 121 or the data line 171.

The first and second subpixel electrodes 192h and 192l form the first and second liquid crystal capacitors Clca and Clcb along with the common electrode 270 of the upper panel and the liquid crystal layer 3 is disposed therebetween to maintain the applied voltage after the thin film transistors (Qa and Qb of FIG. 13) are turned off.

Parts 195 of the first and second subpixel electrodes 192h and 192l overlap the storage electrodes 135a and 135b to form the first and second storage capacitors Csta and Cstb, and thereby, reinforce the voltage storage capacity of the first and second liquid crystal capacitors Clca and Clcb.

The liquid crystal layer 3 is formed on the second passivation layer 185 and the pixel electrode 192. The space where the liquid crystal layer 3 is positioned is referred to as a microcavity layer. The microcavity layer is supported by the overlying roof layer 312. The microcavity layer includes a plurality of microcavities including liquid crystal molecules 310 disposed therein.

An alignment layer (not shown) to align the liquid crystal molecules 310 may be formed between the microcavity layer and the liquid crystal layer 3.

The liquid crystal molecules 310 are initially aligned by the alignment layer and is the alignment direction may be changed based on an applied electric field.

In exemplary embodiments, a portion of the microcavity layer may be opened to form a liquid crystal injection hole 335. As such, the liquid crystal molecules 310 may be injected into the microcavity layer by way of a capillary force through the liquid crystal injection hole 335. It is noted that the alignment layer may also be formed by the capillary force. The liquid crystal injection hole 335 may be sealed by a capping layer (not shown) after the alignment layer and the liquid crystal molecules 310 are injected into the microcavities.

The common electrode 270 is positioned on the microcavity layer and the liquid crystal layer 3. A portion of the structure of the common electrode 270 may be curved (or otherwise extend towards the insulation substrate) along the microcavity layer so as to be above and close to (e.g., extend towards) the data line 171. Further, the common electrode 270 may not be formed in the portion where the liquid crystal injection hole 335 is formed (e.g., not formed in a region where the transistor is formed) to have an extending structure in the gate line direction (e.g., the horizontal direction).

The common electrode 270 may include any suitable transparent conductive material, such as AZO, GZO, ITO, IZO, etc. It is also contemplated that the common electrode 270 may be formed from one or more conductive polymers, e.g., polyaniline, PEDOT:PSS, etc. According to exemplary embodiments, the common electrode 270 may serve to generate an electric field together with the pixel electrode 192, and thereby, configured to control an arrangement direction of the liquid crystal molecules 310.

The lower insulating layer 311 is positioned on the common electrode 270. In exemplary embodiments, the lower insulating layer 311 may include any suitable material, such as, for example, an inorganic insulating material, e.g., silicon nitride (SiNx), silicon oxide (siOx), etc.

The roof layer 312 is formed on the lower insulating layer 311. The roof layer 312 may serve to support a space (microcavity) to be formed between the pixel electrode 192 and the common electrode 270. The roof layer 312, according to exemplary embodiments, is formed of an organic insulator, such as previously described. In this manner, the roof layer 312 may exhibit a relatively higher refractive index than the other layers of the display device.

The upper insulating layer 313 is formed on the roof layer 312. The upper insulating layer 313 may be formed of any suitable material, such as, for example, the inorganic insulating material, e.g., silicon nitride (SiNx), silicon oxide (SiOx), etc.

The lower insulating layer 311, the roof layer 312, and the upper insulating layer 313 may include the liquid crystal injection hole 335 at one side thereof (e.g., formed in a portion corresponding to the transistor formation region), to enable liquid crystal to be injected into the microcavity layer. The liquid crystal injection hole 335 may be used even when removing the sacrificial layer (not shown) for forming the microcavity layer.

Corresponding polarizers (not shown) are respectively positioned below the insulation substrate 110 and above the upper insulating layer 313. The polarizers may include a polarization element for polarization and a triacetylcellulose (TAC) layer for ensuring durability. Directions of the transmissive axes in a polarizer disposed on the upper insulating layer 313 and a polarizer disposed below the insulation substrate 110 may be perpendicular or parallel to each other.

Furthermore, the roof layer 312 may include the convex pattern, such as described in association with one or more of FIGS. 6-10.

While certain exemplary embodiments and implementations have been described herein, other embodiments and modifications will be apparent from this description.

Accordingly, the invention is not limited to such embodiments, but rather to the broader scope of the presented claims and various obvious modifications and equivalent arrangements.

What is claimed is:

1. A liquid crystal display, comprising:
a substrate;
a pixel electrode disposed on the substrate;
a microcavity layer disposed on the pixel electrode, the microcavity layer comprising a plurality of microcavities comprising liquid crystal molecules disposed therein;
a common electrode disposed on the microcavity layer; and
a layer disposed on the common electrode, the layer comprising an organic material,
wherein the layer comprises a refractive index of more than 1.6 and less than 2.0.

2. The liquid crystal display of claim 1, wherein the layer comprises an additive mixed in a solution, the additive comprising a relatively higher refractive index than the organic material.

3. The liquid crystal display of claim 2, wherein the solution is an acrylate, and the additive comprises an organic/inorganic hybrid sol-gel or nano-sized particles.

4. The liquid crystal display of claim 3, wherein the additive comprises a ceramic sol or a monomer.

5. The liquid crystal display of claim 2, further comprising:
a passivation layer disposed between the substrate and the pixel electrode,
wherein the passivation layer comprises the organic material.

6. The liquid crystal display of claim 2, wherein the layer comprises a convex pattern.

7. The liquid crystal display of claim 6, wherein the convex pattern comprises a plurality of convex portions, each convex portion being disposed in association with a corresponding one of the plurality of microcavities.

8. The liquid crystal display of claim 6, wherein the convex pattern comprises at least one convex portion disposed in association with a plurality of adjacently disposed ones of the plurality of microcavities.

9. The liquid crystal display of claim 6, wherein the convex pattern comprises a plurality of undulations, each of the plurality of microcavities being associated with a corresponding plurality of the plurality of undulations.

10. The liquid crystal display of claim 9, wherein a pitch between directly adjacent undulations is 2 to 50 μm.

11. The liquid crystal display of claim 9, further comprising:
a backlight unit,
wherein the substrate is disposed on the backlight unit and the backlight unit is configured to provide light to the substrate.

12. The liquid crystal display of claim 9, further comprising:
a backlight unit,
wherein the layer is disposed between the backlight unit and the substrate, and
wherein the backlight unit is configured to provide light to the layer.

13. A liquid crystal display, comprising:
a substrate;
a pixel electrode disposed on the substrate;
a microcavity layer disposed on the pixel electrode, the microcavity layer comprising a plurality of microcavities comprising liquid crystal molecules disposed therein;
a common electrode disposed on the microcavity layer; and
a layer disposed on the common electrode,
wherein the layer comprises a convex pattern.

14. The liquid crystal display of claim 13, wherein the convex pattern comprises a plurality of convex portions, each convex portion being disposed in association with a corresponding one of the plurality of microcavities.

15. The liquid crystal display of claim 13, wherein the convex pattern comprises at least one convex portion disposed in association with a plurality of adjacently disposed ones of the plurality of microcavities.

16. The liquid crystal display of claim 15, wherein the convex pattern facilitates the display of stereoscopic images.

17. The liquid crystal display of claim 13, wherein the convex pattern comprises a plurality of undulations, each of the plurality of microcavities being associated with a corresponding plurality of the plurality of undulations.

18. The liquid crystal display of claim 17, wherein a pitch between directly adjacent undulations is 2 to 50 μm.

19. The liquid crystal display of claim 17, further comprising:
a backlight unit,
wherein the substrate is disposed on the backlight unit and the backlight unit is configured to provide light to the substrate.

20. The liquid crystal display of claim 17, further comprising:
a backlight unit,
wherein the layer is disposed between the backlight unit and the substrate, and
wherein the backlight unit is configured to provide light to the layer.

21. The liquid crystal display of claim 1, wherein the common electrode covers the microcavity layer and the layer covers the common electrode.

22. The liquid crystal display of claim 1, further comprising:
a light blocking member comprising a plurality of apertures,
wherein the microcavity layer is disposed on the light blocking member and the plurality of apertures expose corresponding ones of the plurality of microcavities.

23. The liquid crystal display of claim 22, wherein portions of the common electrode are bent toward the substrate between corresponding ones of the plurality of apertures.

24. The liquid crystal display of claim 4, wherein the ceramic sol comprises at least one of silicon dioxide (SiO₂), titanium dioxide (TiO₂), aluminum oxide (Al₂O₃), and zirconium dioxide (ZrO₂).

25. The liquid crystal display of claim 13, wherein the common electrode covers the microcavity layer and the layer covers the common electrode.

26. The liquid crystal display of claim 13, further comprising:
a light blocking member comprising a plurality of apertures,
wherein the microcavity layer is disposed on the light blocking member and the plurality of apertures expose corresponding ones of the plurality of microcavities.

27. The liquid crystal display of claim 26, wherein portions of the common electrode are bent toward the substrate between corresponding ones of the plurality of apertures.
